(19) United States
(12) Patent Application Publication
(10) Pub. No.: US 2010/0297486 A1
(43) Pub. Date: Nov. 25, 2010

(54) BATTERY SYSTEM

(76) Inventor: Kazuhiro Fujii, Taka cho (JP)

Correspondence Address: WENDEROTH, LIND & PONACK, L.L.P., 1030 15th Street, N.W.,, Suite 400 East, Washington, DC, 20005-1503, US

(21) Appl. No.: 12/781,255

(22) Filed: May 17, 2010

(30) Foreign Application Priority Data
May 19, 2009 (JP) 2009-121337

(51) Int. Cl. H01M 10/50

(52) U.S. Cl. 429/120

(57) ABSTRACT

The battery system comprises battery blocks 3 having a plurality of stacked battery cells 1, ventilating ducts that are supply ducts and exhaust ducts 7 disposed on each side of the battery blocks 3, and ventilating apparatus 9. Cooling gas is forced to flow from the supply ducts through cooling gaps 4 and into the exhaust ducts 7 to cool the battery cells 1. The battery system has temperature equalizing plates 15 disposed on the supply duct sides of the battery blocks 3. These temperature equalizing plates 15 are provided with mass-flow regulating openings 16 extending in the battery cell 1 stacking direction. The area exposed by the mass-flow regulating openings 16 varies with position in the battery cell 1 stacking direction, and supply duct cooling gas passes through the mass-flow regulating openings 16 into each cooling gap 4 to equalize the temperature of all the battery cells 1.

### BACKGROUND OF THE INVENTION

1. Field of the Invention

The present invention relates to a battery system provided with ventilating ducts on both sides of battery blocks having a plurality of horizontally stacked battery cells, and the battery cells are cooled by forced ventilation from the ventilating ducts through cooling gaps in the battery blocks.

2. Description of the Related Art

A battery system, which has many stacked battery cells that are cooled by forced ventilation through cooling gaps between the battery cells, can develop temperature differences between individual battery cells. In particular, as the number of stacked battery cells increases, it becomes difficult to uniformly cool all the battery cells to minimize temperature differences. In a battery system with many battery cells stacked together, it is extremely important to reduce temperature differences between battery cells as much as possible. This is because battery cell temperature differences generate non-uniform remaining battery cell capacity, and as a result, the lifetime of a particular battery cell is shortened. Since charging and discharging efficiency varies with battery temperature, remaining capacity differences are caused by temperature differences even when all the batteries are charged and discharged with the same current. When remaining capacity differences develop, batteries with high remaining capacity are easily over-charged and batteries with low remaining capacity are easily over-discharged. As a result of over-charging or over-discharging, degradation of a particular battery cell is accelerated, and this is the cause of reduced lifetime of the battery system. This type of battery system has many batteries stacked together for use in applications that charge and discharge with high currents such as in a hybrid car. Therefore, since manufacturing cost is extremely high, it is important to extend battery system lifetime as much as possible. Specifically, since battery system cost increases with the number of batteries used, longer lifetime is demanded for systems with a large number of batteries. However, a characteristic of these battery systems is that the more batteries that are stacked together, the greater the temperature differences, and the shorter the lifetime.

A battery system having a plurality of stacked battery cells that are cooled by forced ventilation of a cooling gas between battery cells has been developed (refer to Japanese Laid-Open Patent Publication 2007-250515).

As shown in the cross-section of FIG. 1, the battery system cited in JP 2007-250515 A has cooling gaps 104 established between battery cells 101 of the battery block 103, and a supply duct 106 and exhaust duct 107 are provided on the sides of the battery block 103. In this battery system, the battery cells 101 are cooled by forced ventilation of cooling gas from the supply duct 106 through the cooling gaps 104 and out the exhaust duct 107.

In a battery system with many battery cells stacked together, battery cells at the upstream end (closer to the cooling gas source) of the supply duct are more efficiently cooled than battery cells at the downstream end. As a result, the temperature of upstream battery cells is low, the temperature of downstream battery cells is high, and battery cell temperature differences develop. To resolve this drawback, the battery system of FIG. 1 is provided with a cooling gas flow diversion piece 115 in the upstream end of the supply duct 106. The cooling gas flow diversion piece 115 projects into the supply duct 106 and reduces the flow of cooling gas into cooling gaps 104 between the upstream battery cells 101 to avoid lower battery cell temperature in those battery cells 101.

The battery system of FIG. 1 increases the temperature of the upstream battery cells 101 via the cooling gas flow diversion piece 115 to reduce battery cell 101 temperature differences. However, this battery system prevents temperature reduction in the battery cells at the upstream end of the supply duct, and cannot control each individual battery cell for a uniform temperature distribution. Consequently, this battery system has the drawback that the temperature of each battery cell cannot be equalized in a system with many battery cells stacked together. In addition, the battery system detects battery cell temperature and controls the amount of power supplied to a ventilating fan that forces cooling gas through the cooling ducts. When battery cell temperature becomes high, power to the ventilating fan is increased to increase the amount of cooling gas flow. As a result, the flow rate of cooling gas through the supply duct changes. In a battery system with a cooling gas flow diversion piece installed in the upstream end of the supply duct, the cooling gas flow configuration in the supply duct varies with the cooling gas flow rate. For example, the wake vortex region created downstream of the cooling gas flow diversion piece changes position and shape depending on the flow rate. Consequently, the position and cooling conditions of the battery cells with restrained cooling changes according to the flow rate of cooling gas through the supply duct. Therefore, this battery system also has the drawback that it is difficult to reduce temperature differences among all the battery cells under conditions where the amount of cooling gas flow forced through the supply duct changes.

The present invention was developed with the object of further resolving the drawbacks described above. Thus, it is an object of the present invention to provide a battery system that can reduce battery cell temperature differences and extend system lifetime while maintaining an extremely simple structure.

### SUMMARY OF THE INVENTION

In the first aspect of the present invention, the battery system is provided with battery blocks 3, 30 having a plurality of battery cells 1 stacked with intervening cooling gaps 4, ventilating ducts 5, 55 that are supply ducts 6, 56 and exhaust ducts 7, 57 disposed on each side of the battery blocks 3, 30 to forcibly pass cooling gas through the cooling gaps 4 to cool the battery cells 1, and ventilating apparatus 9 to force cooling gas to flow through the ventilating ducts 5, 55. Cooling gas forcibly introduced by the ventilating apparatus 9 flows from the supply ducts 6, 56 through the cooling gaps 4 and into the exhaust ducts 7, 57 to cool the battery cells 1. The battery system has temperature equalizing plates 15, 35 disposed on the supply duct 6, 56 sides of the battery blocks 3, 30. These temperature equalizing plates 15, 35 establish mass-flow regulating openings 16, 36 extending in the battery cell 1 stacking direction to control the flow of supply duct 6, 56 cooling gas into each cooling gap 4. Further, the area exposed by the mass-flow regulating openings 16, 36 at each battery cell 1 is a function of position in the battery cell 1 stacking direction, and supply duct 6, 56 cooling gas passes through the mass-flow regulating openings 16, 36 into each respective cooling gap 4 to equalize the temperature of all the battery cells 1.

The battery system described above has the characteristic that temperature differences between battery cells can be reduced to extend system lifetime while maintaining an extremely simple structure. This is because the amount of cooling gas flowing into each cooling gap from the supply duct is controlled by temperature equalizing plates provided on the supply duct side surfaces of the battery blocks.

Further, the battery system described above also achieves the characteristic that pressure losses in the cooling gas flow supplied by the supply duct can be reduced while reducing temperature differences between the battery cells. This is because battery cell temperature differences are reduced by providing temperature equalizing plates in the supply ducts that cause the cooling gas to flow smoothly.

In the second aspect of the present invention, the battery system is provided with battery blocks 3, 30 having a plurality of battery cells 1 stacked with intervening cooling gaps 4, ventilating ducts 5, 55 that are supply ducts 6, 56 and exhaust ducts 7, 57 disposed on each side of the battery blocks 3, 30 to forcibly pass cooling gas through the cooling gaps 4 to cool the battery cells 1, and ventilating apparatus 9 to force cooling gas to flow through the ventilating ducts 5, 55. Cooling gas forcibly introduced by the ventilating apparatus 9 flows from the supply ducts 6, 56 through the cooling gaps 4 and into the exhaust ducts 7, 57 to cool the battery cells 1. The battery system has temperature equalizing plates 45, 35 disposed on the exhaust duct 6, 56 sides of the battery blocks 3, 30. These temperature equalizing plates 45, 35 establish mass-flow regulating openings 46, 36 extending in the battery cell 1 stacking direction to control the flow of cooling gas through each cooling gap 4 into the exhaust duct 7, 57. Further, the area exposed by the mass-flow regulating openings 46, 36 at each battery cell 1 is a function of position in the battery cell 1 stacking direction, and cooling gas that passes through each respective cooling gap 4 flows through the mass-flow regulating openings 46, 36 out to an exhaust duct 7, 57 to equalize the temperature of all the battery cells 1.

The battery system described above has the characteristic that temperature differences between battery cells can be reduced to extend system lifetime while maintaining an extremely simple structure. This is because the amount of cooling gas flowing out of each cooling gap into the exhaust duct is controlled by temperature equalizing plates provided on the exhaust duct side surfaces of the battery blocks.

In the battery system of the first and second aspects of the present invention, battery cell temperature differences can be reduced by adjusting the mass-flow regulating openings established by the temperature equalizing plates. In particular, these battery systems have the characteristic that even if the number of stacked battery cells is changed, battery cell temperature differences can be reduced in an extremely simple manner by adjusting the mass-flow regulating openings.

Further, since only the shape of the temperature equalizing plate mass-flow regulating openings need to be adjusted to reduce battery cell temperature differences, the battery systems have the characteristic that battery cell temperature differences can be further reduced by an extremely simple design modification. Therefore, the battery systems have the characteristic that even if battery block shape and structure is changed, battery cell temperature differences can be reduced by changing the mass-flow regulating openings. This is particularly useful in battery systems that require changing the number of stacked battery cells depending on the model of the automobile to be powered. This is because even when the number of stacked battery cells changes, battery cell temperature differences can be reduced by simply changing the temperature equalizing plate mass-flow regulating openings.

A battery block 3, 30 of the battery system of the present invention can be configured with a battery stack 8 having a plurality of battery cells 1 stacked together, a pair of endplates 10 disposed at the ends of the battery stack 8, and connecting bands 11, 31 that connect the pair of endplates 10 to sandwich the battery stack 8 from both ends and hold the battery cells 1 in a stacked arrangement.

In the battery system of the present invention, temperature equalizing plates 15, 45 can be attached in a layered arrangement on the connecting bands 11, 31. This battery system has the characteristic that battery cell temperature differences can be reduced with an extremely simple structure by disposing temperature equalizing plates in a layered configuration on the connecting bands.

In the battery system of the present invention, the temperature equalizing plates 35 can be integrated in single-piece configuration with the connecting bands 31. In this battery system, since the shape of the connecting bands is changed to establish the temperature equalizing plates, battery cell temperature differences can be reduced by the connecting bands. Consequently, battery cell temperature differences can be reduced with an extremely simple structure and without the effort of attaching temperature equalizing plates. Further, since temperature equalizing plates are implemented by connecting bands robustly attached to the battery blocks, battery cell temperature differences can be reduced over a long period without any position shift in the temperature equalizing plates.

In the battery system of the present invention, the surface area opened by the mass-flow regulating openings 16, 46, 36 of the temperature equalizing plates 15, 45, 35 can be smaller at the upstream end than at the downstream end. This battery system can reduce battery cell temperature differences with temperature equalizing plates having a simple shape.

In the battery system of the present invention, the vertical width of the mass-flow regulating openings 16, 46, 36 of the temperature equalizing plates 15, 45, 35 can be narrower at the upstream end than at the downstream end to reduce the surface area opened at the upstream end. This battery system can reduce battery cell temperature differences by limiting cooling gas flow into the cooling gaps of upstream battery cells with temperature equalizing plates having a simple shape.

In the battery system of the present invention, connecting bands 11, 31 can be disposed at the top and bottom of the battery stacks 8. In this battery system, cooling gas can flow smoothly into the cooling gaps for efficient cooling while disposing connecting bands on both sides of the battery stacks.

In the battery system of the present invention, a connecting band 11, 31 can have an upper band 11A, 31A and a lower band 11B, 31B disposed at the top and bottom of a battery stack 8 that are joined together at both ends, and the joined regions 11C, 31C at both ends can be attached to the endplates 10. Since the upper and lower bands of this battery system are joined together, the connecting bands can easily be attached to the endplates. In particular, in a configuration that attaches the connecting bands to the endplates via set screws, this battery system has the characteristic that rotation of the connecting bands can be prevented during set screw tightening allowing simple, reliable attachment to the endplates.

The above and further objects of the present invention as well as the features thereof will become more apparent from the following detailed description to be made in conjunction with the accompanying drawings.

### BRIEF DESCRIPTION OF THE DRAWINGS

FIG. 1 is a horizontal cross-section view of a prior art battery system;

FIG. 2 is an oblique view of a battery system for the first embodiment of the present invention;

FIG. 3 is an oblique cross-section view showing the internal structure of the battery system shown in FIG. 2;

FIG. 4 is an oblique view showing the internal structure of the battery system shown in FIG. 2;

FIG. 5 is an oblique view showing the battery system shown in FIG. 4 with the front row of battery blocks removed;

FIG. 6 is a horizontal cross-section view of the battery system shown in FIG. 2;

FIG. 7 is a vertical cross-section through the line VII-VII of FIG. 6 for the battery system shown in FIG. 2;

FIG. 8 is a vertical cross-section through the line VIII-VIII of FIG. 6 for the battery system shown in FIG. 2;

FIG. 9 is an exploded oblique view of a battery block of the battery system shown in FIG. 5;

FIG. 10 is an exploded oblique view showing the stacking configuration for battery cells and spacers.

FIG. 11 is an oblique view of a connecting band of the battery block shown in FIG. 9.

FIG. 12 is an oblique view of a temperature equalizing plate of the battery block shown in FIG. 9.

FIG. 13 is an exploded oblique view showing another example of a battery block;

FIG. 14 is an oblique view of a connecting band of the battery block shown in FIG. 13.

FIG. 15 is an oblique cross-section view of a battery system for the second embodiment of the present invention;

FIG. 16 is an oblique view showing the internal structure of the battery system shown in FIG. 15;

FIG. 17 is a horizontal cross-section view of the battery system shown in FIG. 15;

FIG. 18 is a vertical cross-section through the line XVIII-XVIII of the battery system shown in FIG. 17;

FIG. 19 is an oblique cross-section view of a battery system for the third embodiment of the present invention;

FIG. 20 is an oblique view showing the internal structure of the battery system shown in FIG. 19;

FIG. 21 is a horizontal cross-section view of the battery system shown in FIG. 19;

FIG. 22 is an oblique cross-section view of a battery system for the fourth embodiment of the present invention;

FIG. 23 is an oblique view showing the battery system shown in FIG. 22 with the front row of battery blocks removed; and

FIG. 24 is a horizontal cross-section view of the battery system shown in FIG. 22.

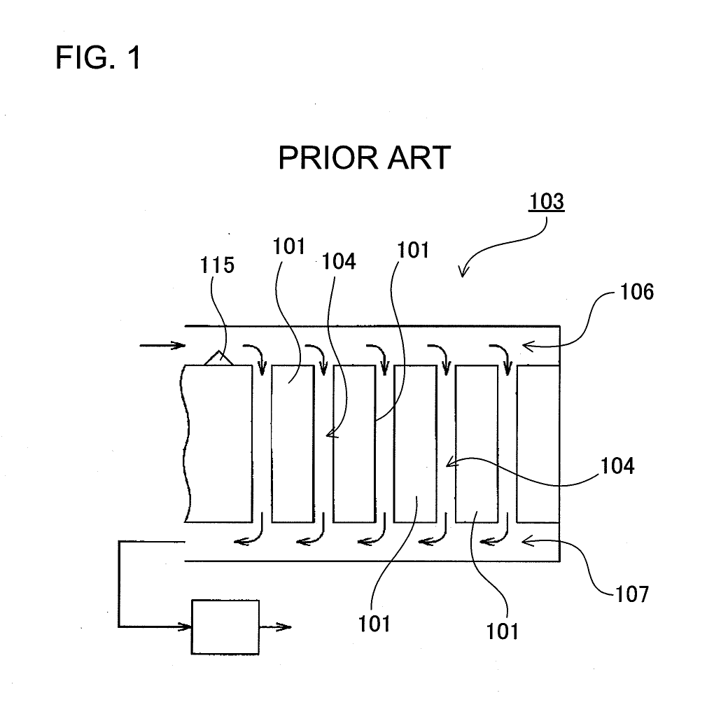

### DETAILED DESCRIPTION OF THE PREFERRED EMBODIMENT(S)

The following describes embodiments of the present invention based on the figures.

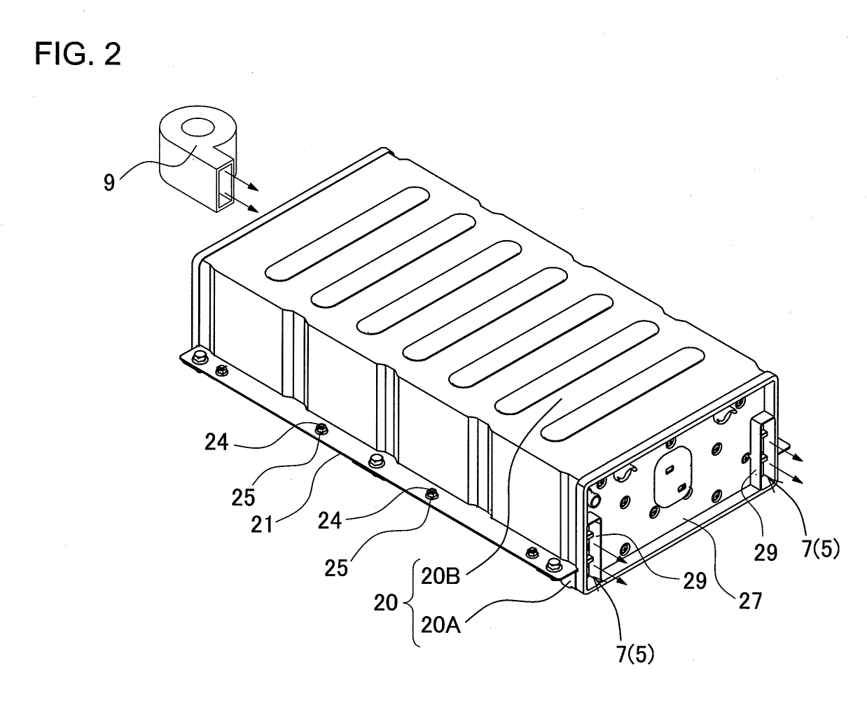

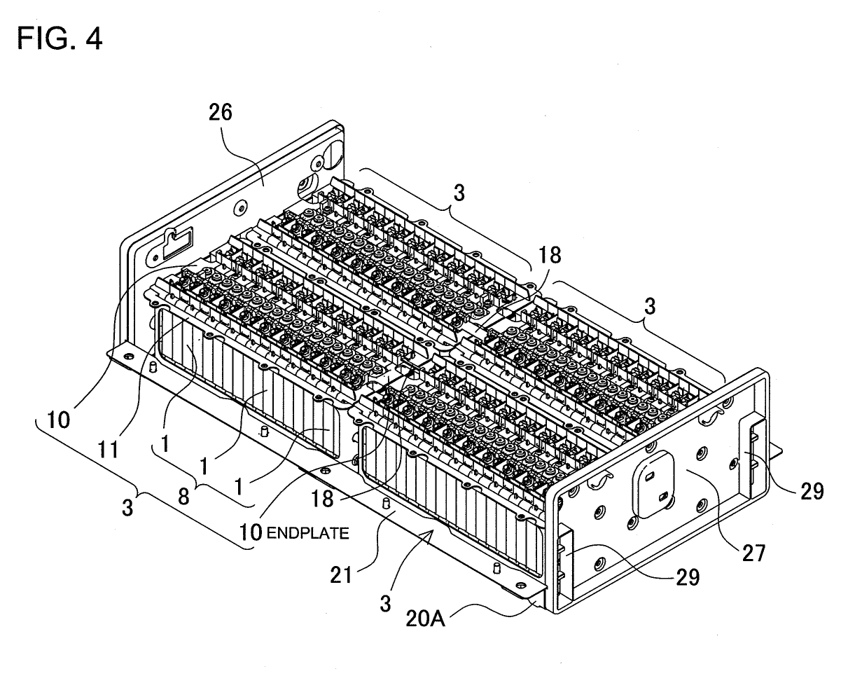

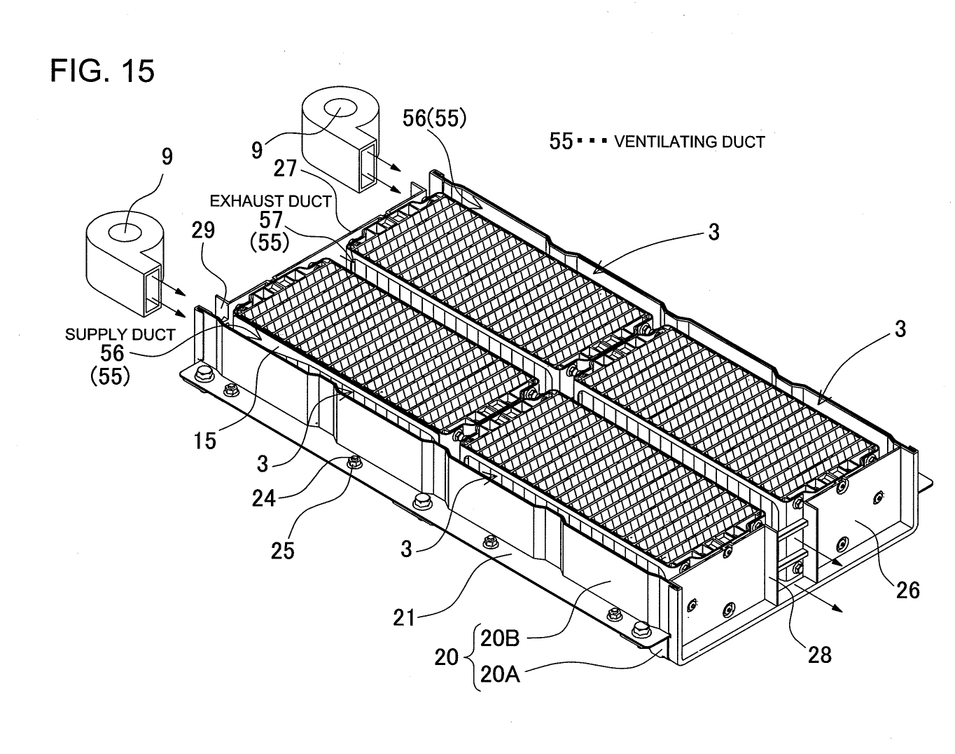

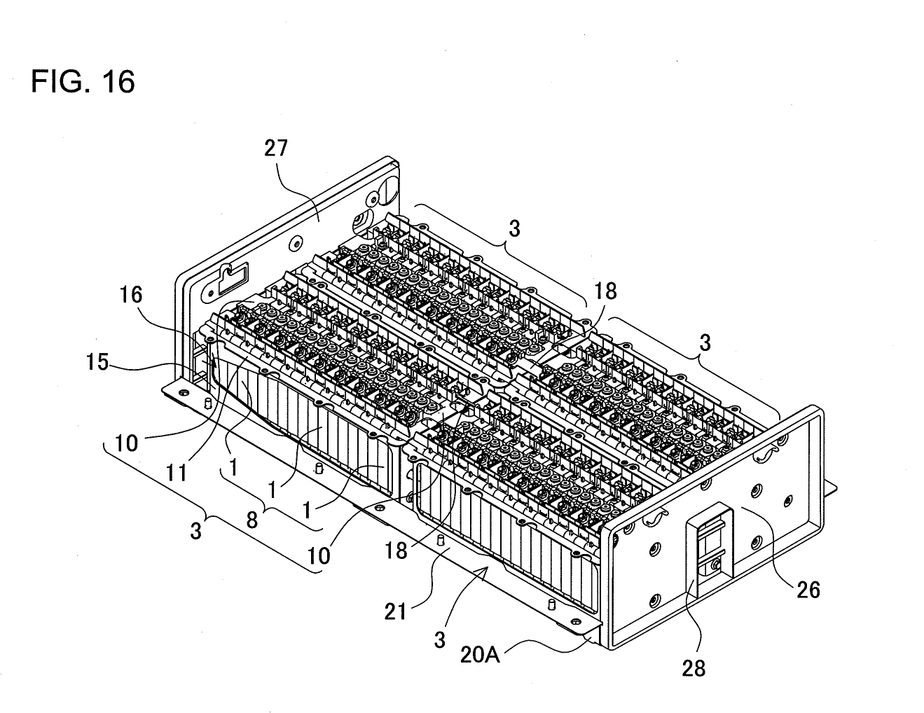

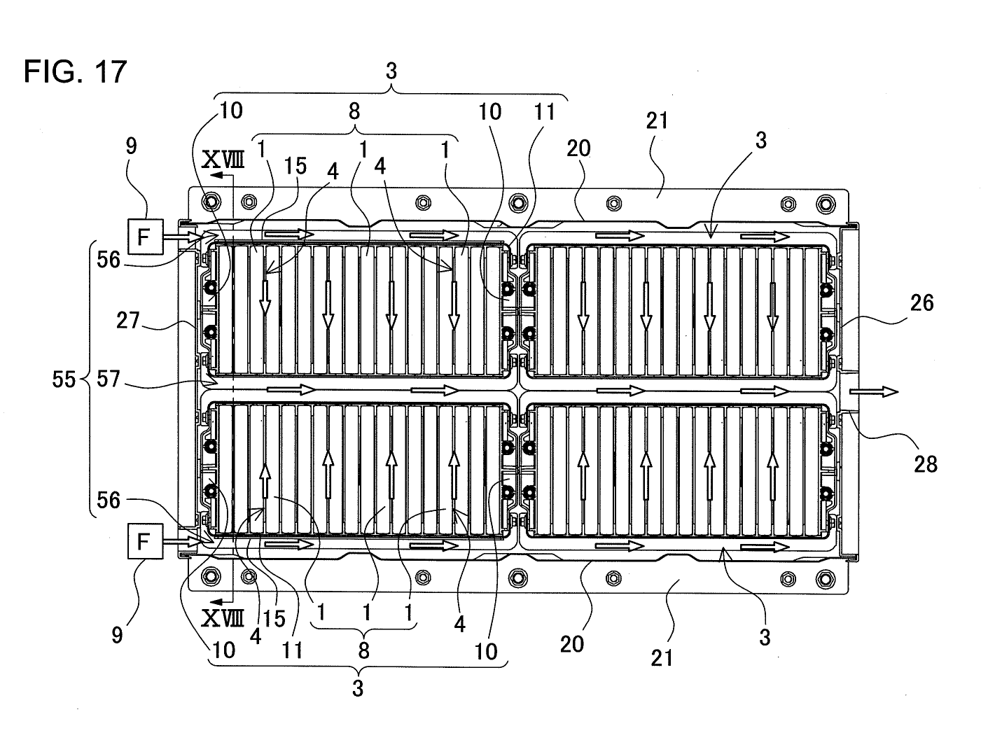

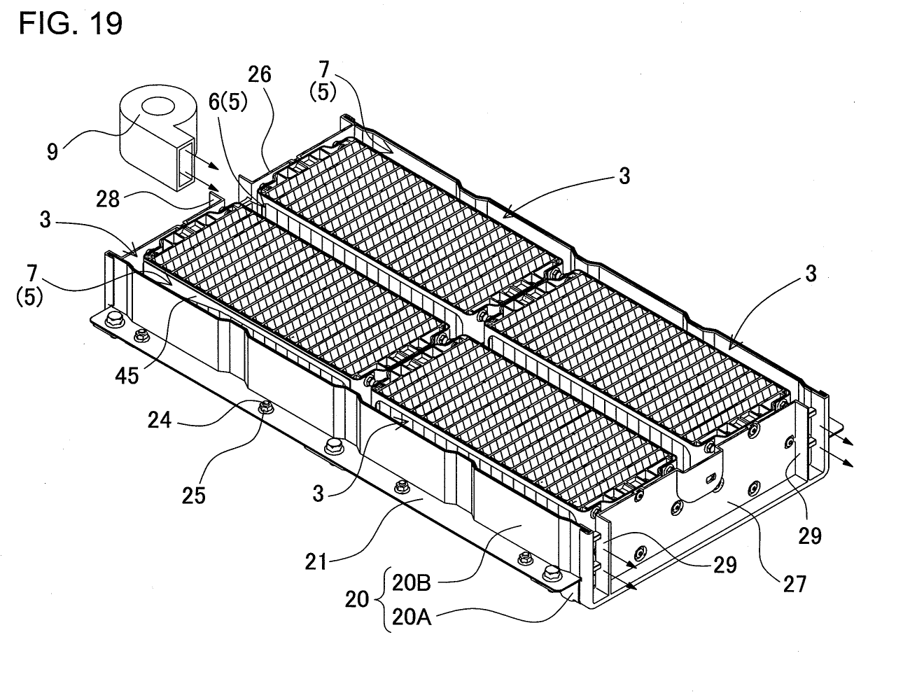

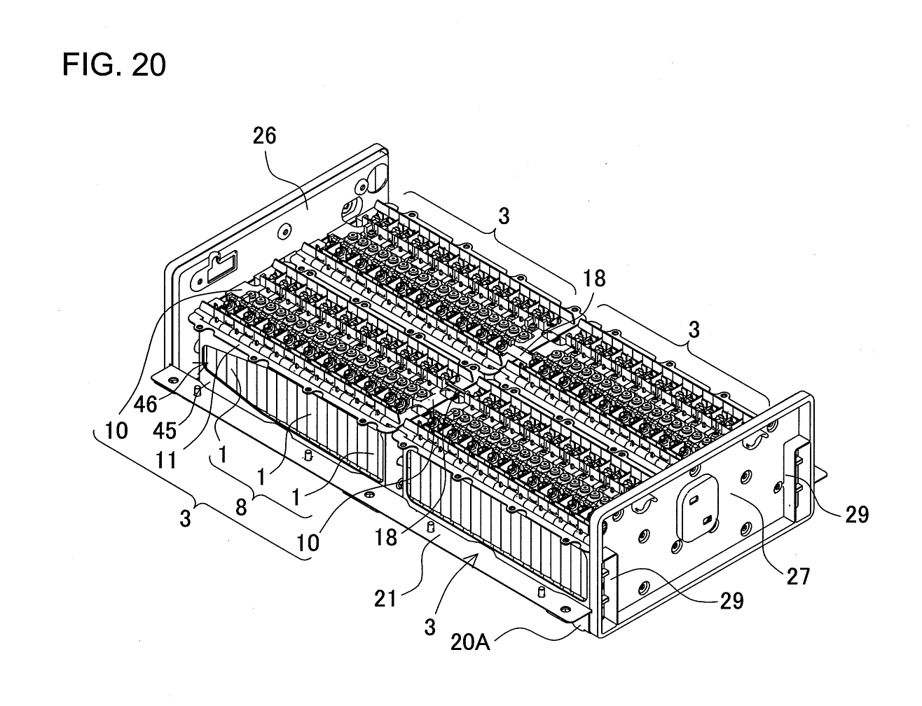

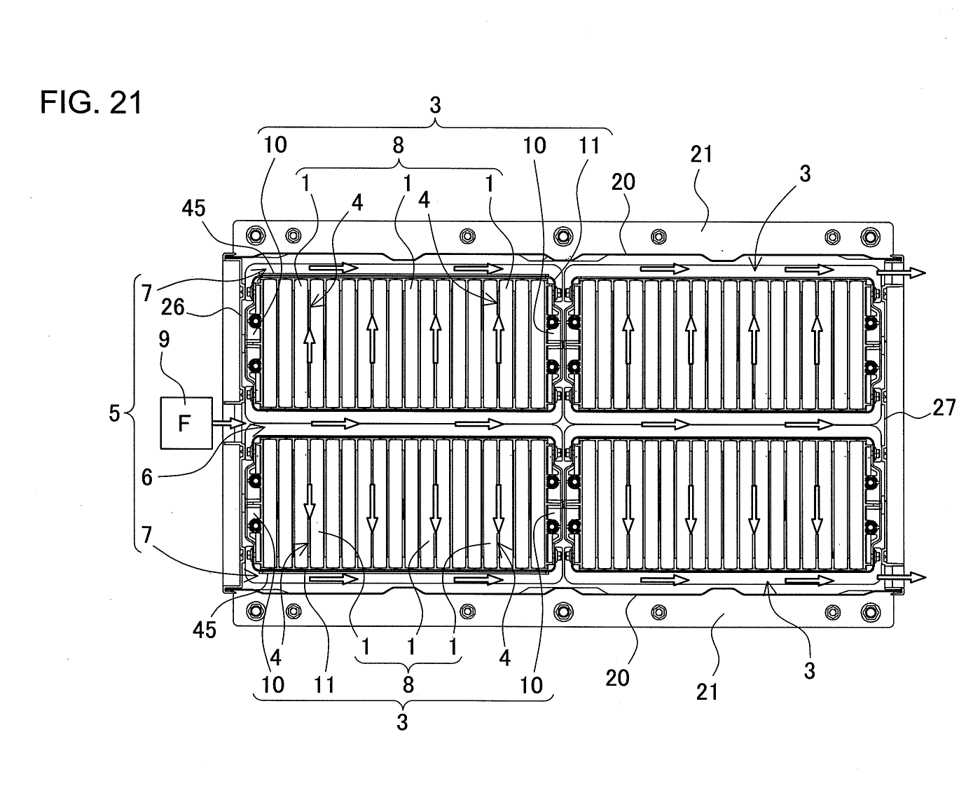

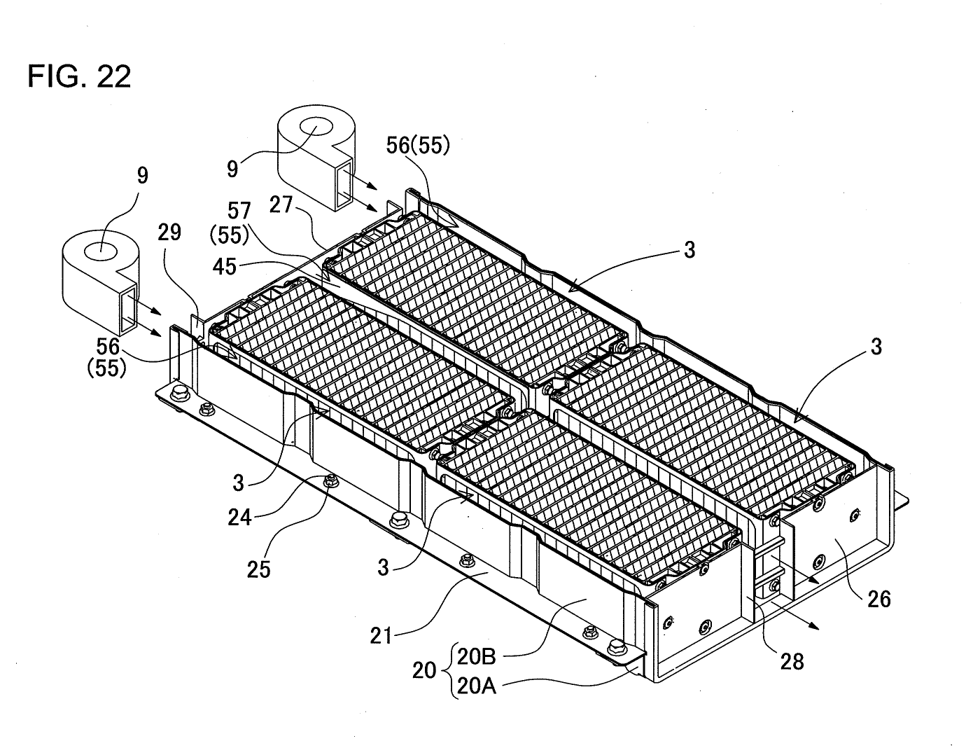

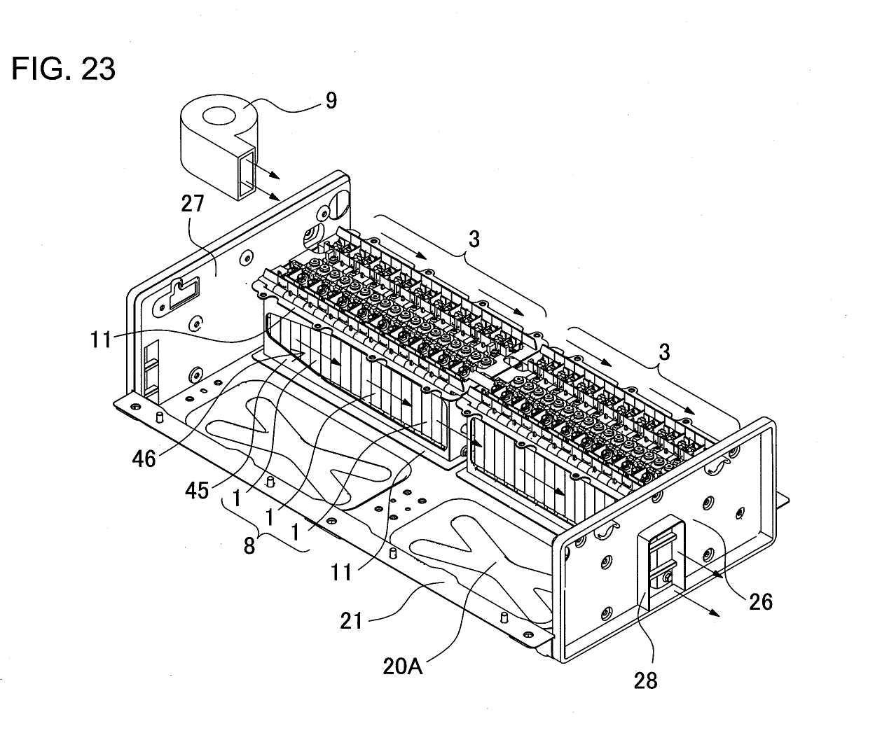

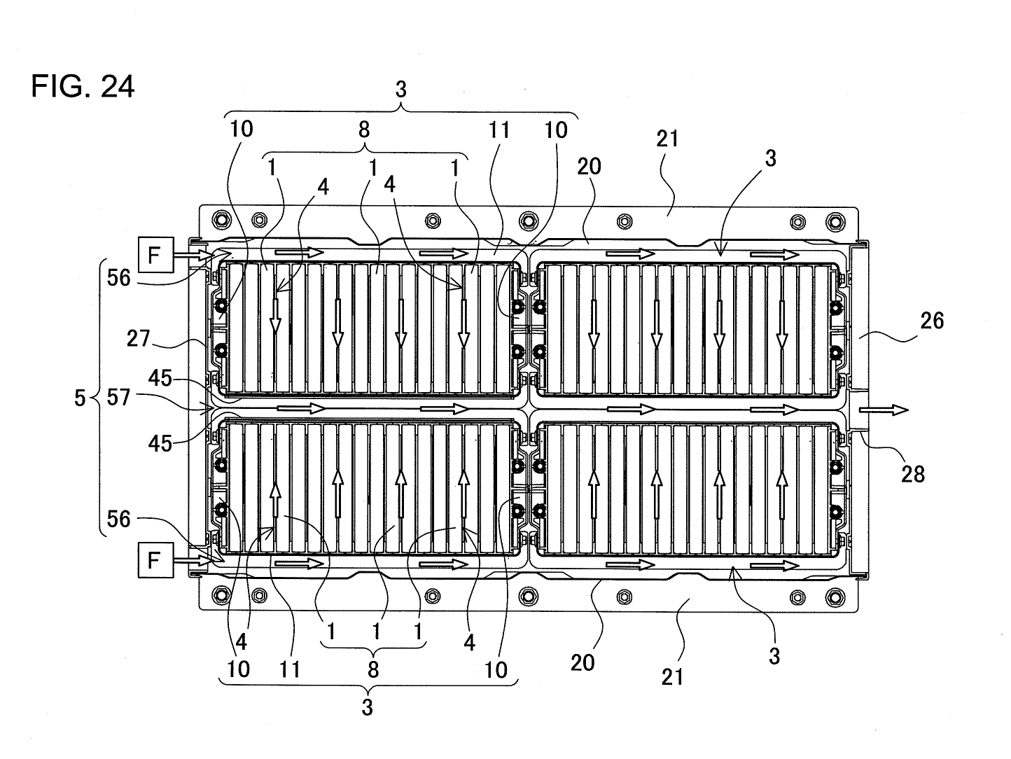

FIGS. 2-8 show the first embodiment of the present invention, FIGS. 15-18 show the second embodiment of the present invention, FIGS. 19-21 show the third embodiment of the present invention, and FIGS. 22-24 show the fourth embodiment of the present invention. The battery systems described in these embodiments are primarily suitable for use as power sources in electric powered vehicles such as in a hybrid car or plug-in hybrid car, which are powered by both an engine and an electric motor, and in an electric automobile (electric vehicle [EV]), which is powered by an electric motor only. However, the present invention can also be used in non-automotive applications where high output is a requirement.

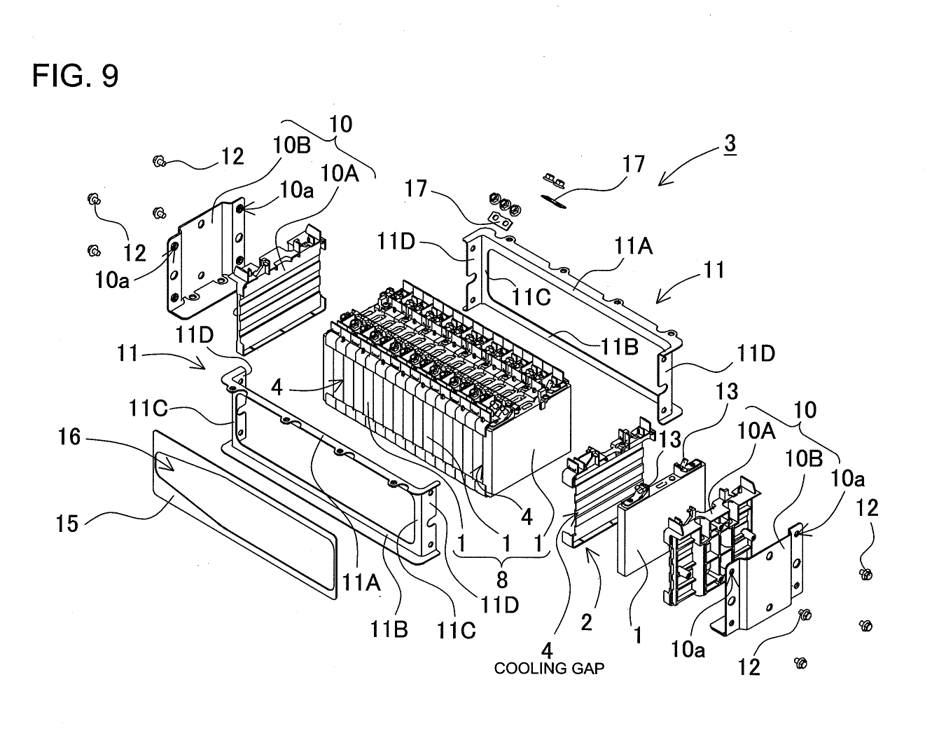

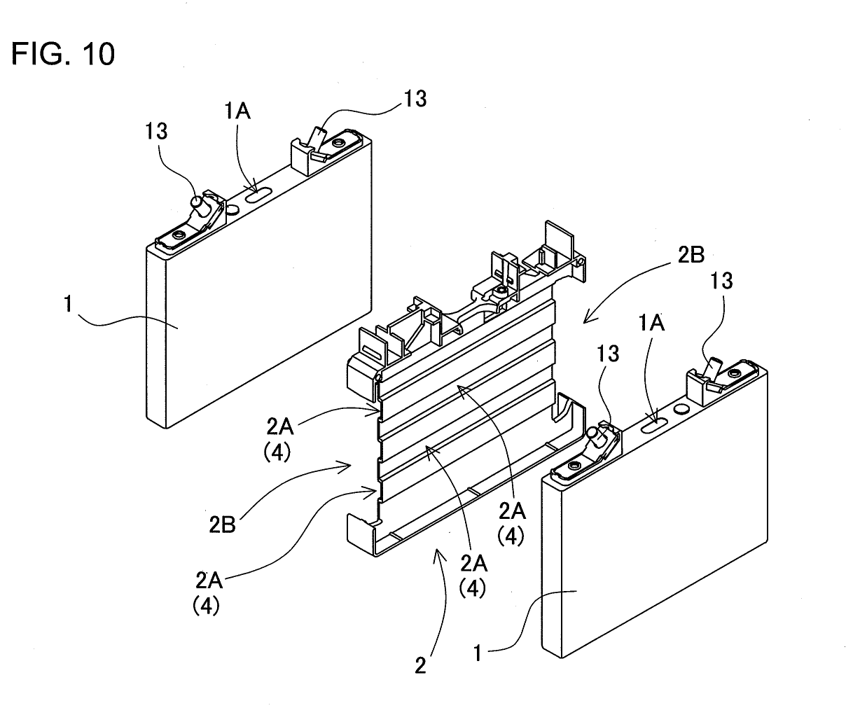

In the following embodiments, the battery system is provided with battery blocks 3 having a plurality of battery cells 1 stacked in a manner establishing cooling gaps 4 between the battery cells 1, and ventilating apparatus 9 that cool the battery cells 1 of the battery blocks 3 by forced ventilation with cooling gas. As shown in FIG. 9, a battery block 3 has spacers 2 sandwiched between the stacked battery cells 1. As shown in FIG. 10, a spacer 2 is shaped in a manner that forms cooling gaps 4 between the battery cells 1. In addition, the spacer 2 of the figures is configured to accept battery cells 1 that fit into both sides. Battery cells 1 are stacked together with adjacent battery cells 1 fit into intervening spacers 2 to prevent position shift.

The battery cells 1 are rectangular lithium ion rechargeable batteries. However, rechargeable batteries such as nickel hydride batteries and nickel cadmium batteries can also be used as the battery cells. A battery cell 1, as shown in the figures, has a rectangular shape of given thickness, has positive and negative electrode terminals 13 protruding from the ends of the top surface, and has a safety valve opening 1A established at the center region of the top surface. Adjacent electrode terminals 13 of the stacked battery cells 1 are connected via bus-bars 17 to connect the batteries in series. A battery system with adjacent battery cells 1 connected in series can establish a high voltage for high output. However, the battery system can also have adjacent battery cells connected in parallel.

A battery cell 1 is made with a metal external case. To prevent short circuits between the external cases of adjacent battery cells 1, insulating spacers 2 are disposed between the battery cells 1. A battery cell can also be made with an external case that is an insulating material such as plastic. In that case, there is no need to insulate the external cases of stacked battery cells, and the spacers can be made from metal.

A spacer 2 is made from an insulating material such as plastic to insulate adjacent battery cells 1. As shown in FIG. 9, the spacers 2 establish cooling gaps 4 between the battery cells 1 to pass a cooling gas such as air to cool the battery cells 1. The spacer 2 shown in FIG. 10 is provided with grooves 2A between the spacer 2 and opposing battery cell 1 surfaces that extend to both side edges and establish cooling gaps 4 between the spacer 2 and battery cells 1. The spacer 2 of the figure is provided with a plurality of parallel grooves 2A spaced at set intervals. The spacer 2 of FIG. 10 has grooves 2A on both sides, and cooling gaps 4 are established between the spacer 2 and both adjacent battery cells 1. This configuration has the characteristic that battery cells 1 on both sides of the spacer 2 can be effectively cooled by the cooling gaps 4 established on both sides of the spacer 2. However, cooling gaps between spacers and battery cells can also be established by providing grooves on only one side of the spacers. The cooling gaps 4 of the figures are established in a horizontal direction to open on both sides of a battery block 3. Further, the spacer 2 of FIG. 10 is provided with cut-out regions 2B on both sides. Here, the gap between adjacent battery cell 1 surfaces is widened at the cut-out regions 2B on both sides allowing cooling gas flow resistance to be reduced. As a result, cooling gas flows smoothly from the cut-out regions 2B to the cooling gaps 4 between the spacer 2 and battery cell 1 surface for effective battery cell 1 cooling. In this manner, forced ventilation of cooling gas through the cooling gaps 4 directly and efficiently cools the battery cell 1 external cases. This structure has the characteristic that battery cells 1 can be efficiently cooled to effectively prevent battery cell 1 thermal runaway.

A battery block 3 is provided with endplates 10 disposed at both ends of the battery cell 1 battery stack 8, and the pair of endplates 10 is connected by connecting bands 11 to solidly hold the battery stack 8. The endplates 10 have essentially the same rectangular outline shape as the battery cells 1.

As shown in FIG. 9, the connecting bands 11 are disposed on both side surfaces of the battery stack 8, and have bent regions 11D that bend inward at both ends and attach to the endplates 10 via set screws 12. Although not illustrated, the connecting bands can also be attached to the side surfaces of the endplates via set screws. In that case, screw-holes can be provided in the sides of the endplates, and set screws can be passed through the connecting bands and screwed into the sides of the endplates. Connecting bands attached to the sides of the endplates do not need bent regions and can be attached to the endplates in a straight-line.

The endplates 10 of FIG. 9 are reinforced by metal plates 10B laminated on the outside surfaces of the main endplates 10A. The main endplates 10A are made of plastic or metal. However, the endplates can also be made entirely of metal or entirely of plastic. Each endplate 10 of the figures has four connecting holes 10a provided in the four corners of the outside surface of the metal plate 10B. Set screws 12 are passed through the bent regions 11D of the connecting bands 11 and screwed into the connecting holes 10a to attach the connecting bands 11 to the endplates 10. The set screws 12 are screwed into nuts (not illustrated) attached to the inside surfaces of the metal plates 10B or the inside surfaces of the main endplates 10A to attach the connecting bands 11 to the endplates 10. Although not illustrated, for endplates made up entirely of metal plates, female screw-holes can be provided to screw in the set screws and attach the connecting bands.

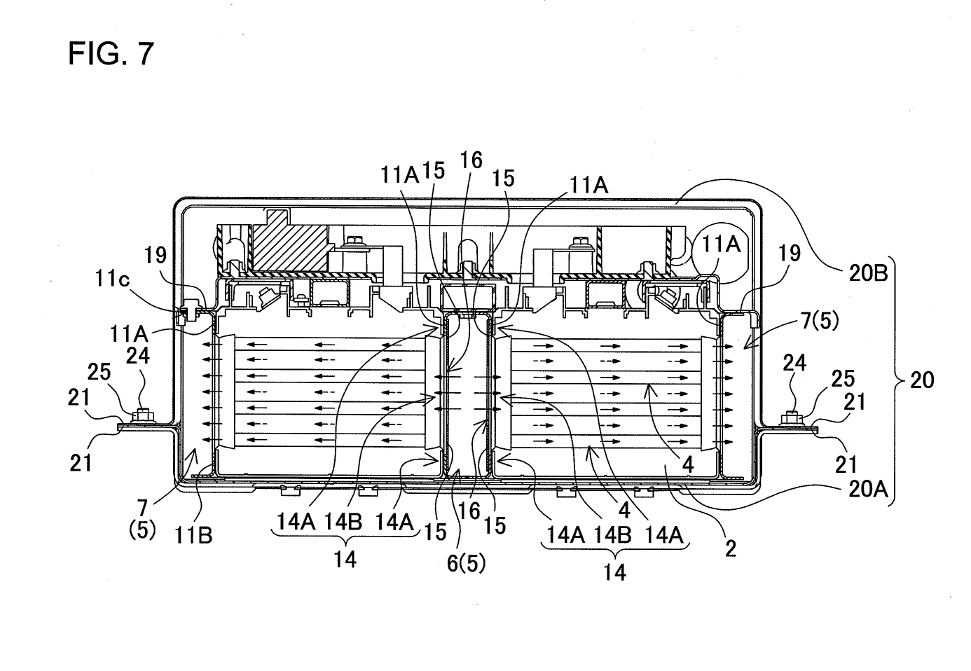

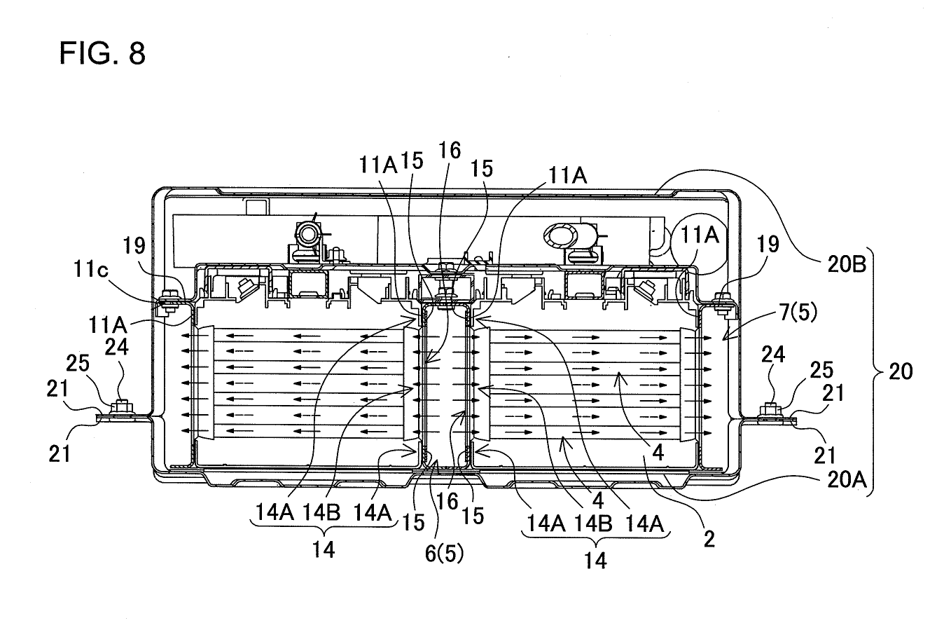

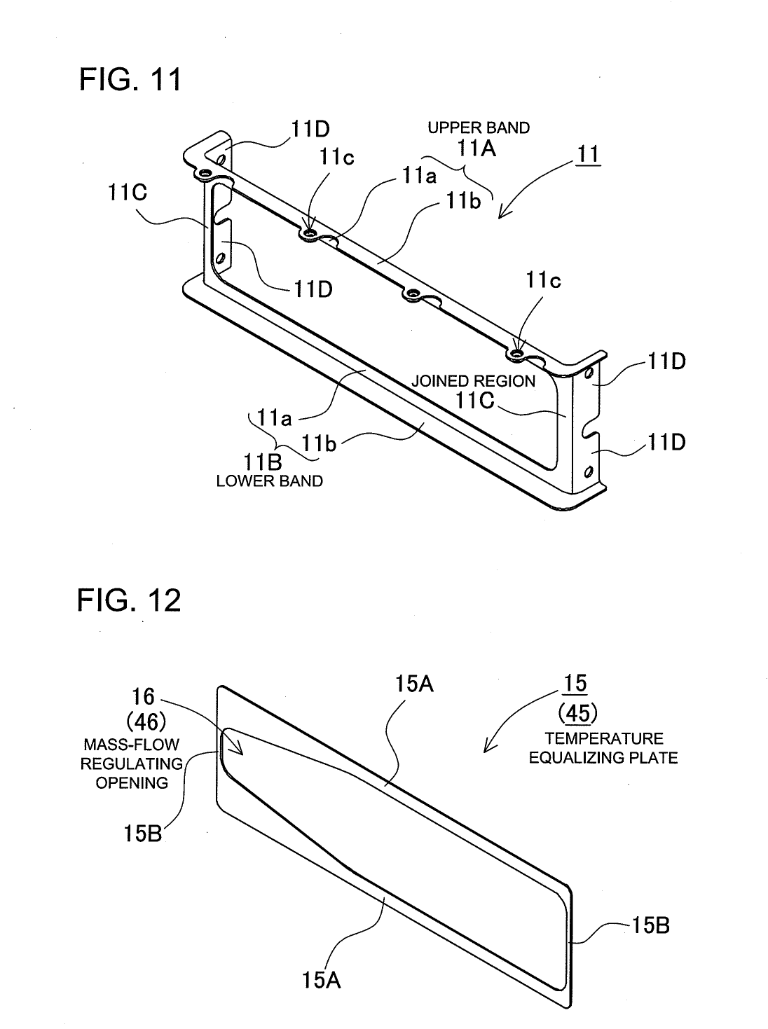

The connecting bands 11 are disposed at the top and bottom of both sides of a battery stack 8, and both ends of the connecting bands 11 are attached to the endplates 10. The connecting bands 11 shown in FIGS. 9 and 11 have upper bands 11A disposed at the upper edges of the battery stack 8, and lower bands 11B disposed at the lower edges of the battery stack 8. Both ends of the connecting bands 11 are joined together at joined regions 11C that attach to the endplates 10. The joined regions 11C of the connecting bands 11 bend inward to conform to the perimeter and outer surfaces of the endplates 10, and the bent regions 11D attach to the endplates 10. These connecting bands 11 are fabricated by sheet-metal cutting and stamping using iron or iron alloy (steel) sheet-metal. Further, the connecting bands 11 of the figures have upper bands 11A and lower bands 11B with L-shaped lateral cross-sections that are formed by connected vertical ribs 11a and horizontal ribs 11b. In these connecting bands 11, the vertical ribs 11a are disposed parallel to the side surfaces of the battery stack 8, and the vertical ribs 11a are reinforced by the horizontal ribs 11b. In addition, the horizontal ribs 11b at the upper edges of the upper bands 11A of the connecting bands 11 of the figures are provided with connecting holes 11c to attach a top plate 19 (refer to FIGS. 7 and 8).

A battery block 3 with connecting bands 11 disposed at the top and bottom of both sides of the battery stack 8 has part of the cooling gap 4 openings 14 between battery cells 1 blocked at the top and bottom by the connecting bands 11. Specifically, cooling gas cannot enter the openings 14 of the cooling gaps 4 blocked by the connecting bands 11. As a result, the openings 14 of the cooling gaps 4 on both sides of the battery cells 1 can be divided into blocked regions 14A, which are blocked at the top and bottom by the connecting bands 11, and exposed regions 14B, which are not blocked by the connecting bands 11. The exposed regions 14B are between the upper and lower blocked regions 14A, and connect with the ventilating ducts 5. Exposed regions 14B connect with a supply duct 6 and cooling gas is forcibly introduced into the exposed region 14B cooling gaps 4 from the supply duct 6. Since connecting bands 11 are disposed at the top and bottom of both sides of a battery block 3, the cooling gaps 4 on both sides of the battery block 3 are divided into those in the blocked regions 14A at the top and bottom connecting bands 11 and those in the exposed regions 14B. Exposed regions 14B on one side of the battery block 3 connect with a supply duct 6, exposed regions 14B on the other side connect with an exhaust duct 7, and the battery cells 1 are cooled by forced ventilation of cooling gas through the cooling gaps 4 of those exposed regions 14B.

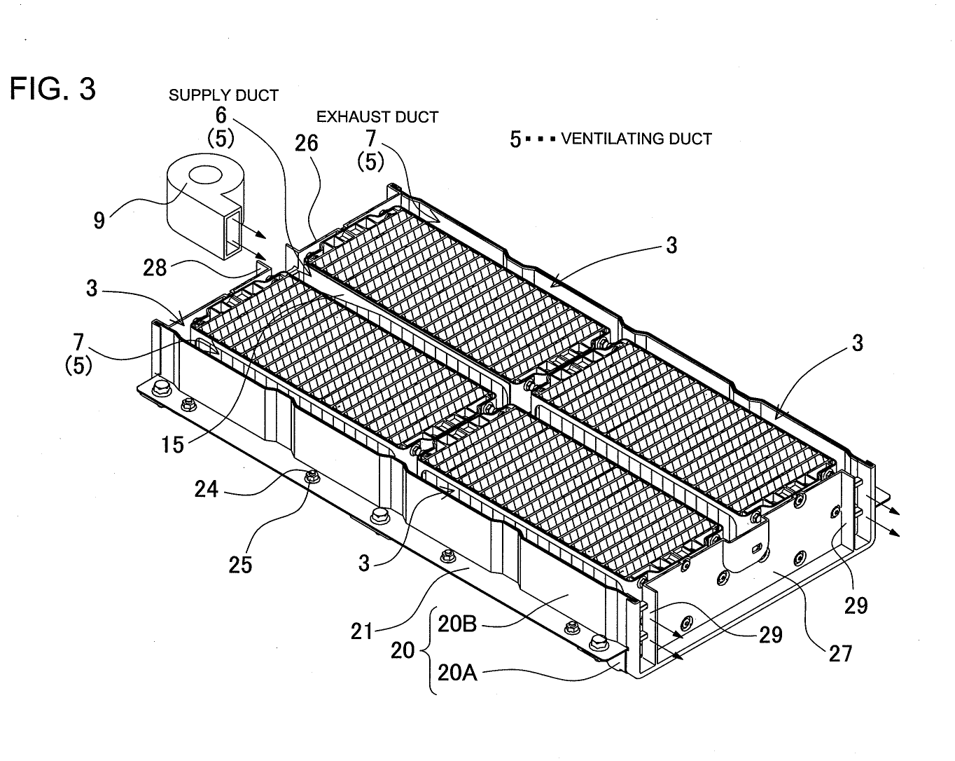

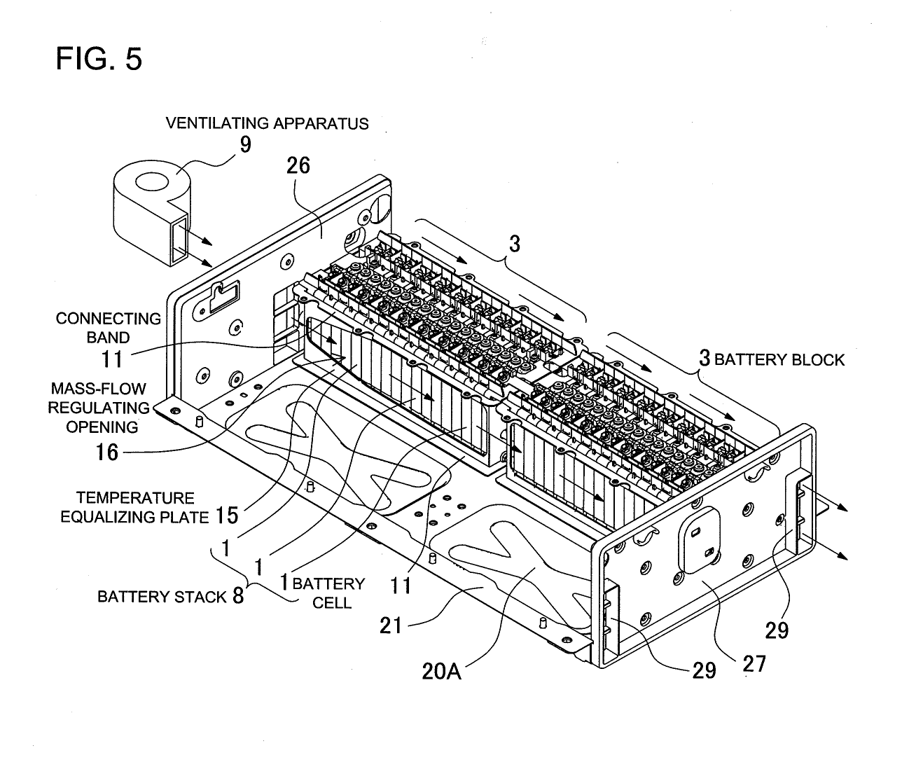

The battery system of FIGS. 3, 5, and 6 has temperature equalizing plates 15 attached to the supply duct 6 side surfaces of the battery blocks 3 to reduce battery cell 1 temperature differences. A temperature equalizing plate 15 is sheet-metal or a heat resistant plastic plate provided with a mass-flow regulating opening 16 passing through the temperature equalizing plate 15. As shown in FIG. 9, the battery system of FIGS. 5-8 has temperature equalizing plates 15 attached in a laminated manner to the outside of the connecting bands 11. These temperature equalizing plates 15 are attached by bonding to the connecting bands 11. Although not illustrated, the temperature equalizing plates can also be attached to the surfaces of the connecting bands by a snap-fit arrangement or with set screws. Further, the temperature equalizing plates can also be attached between the connecting bands and the battery stack.

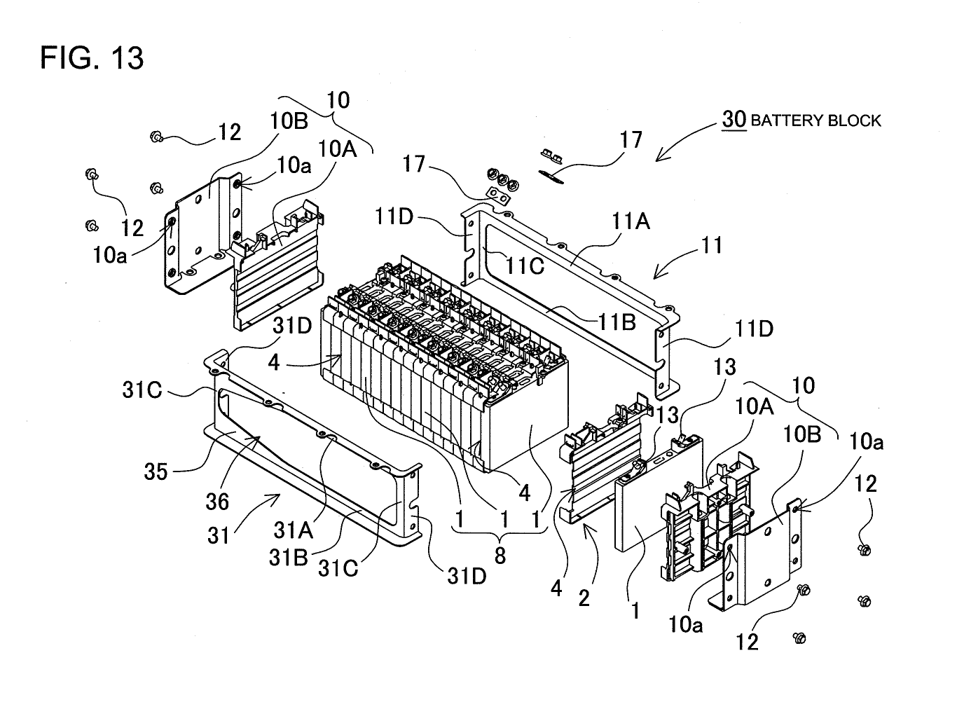

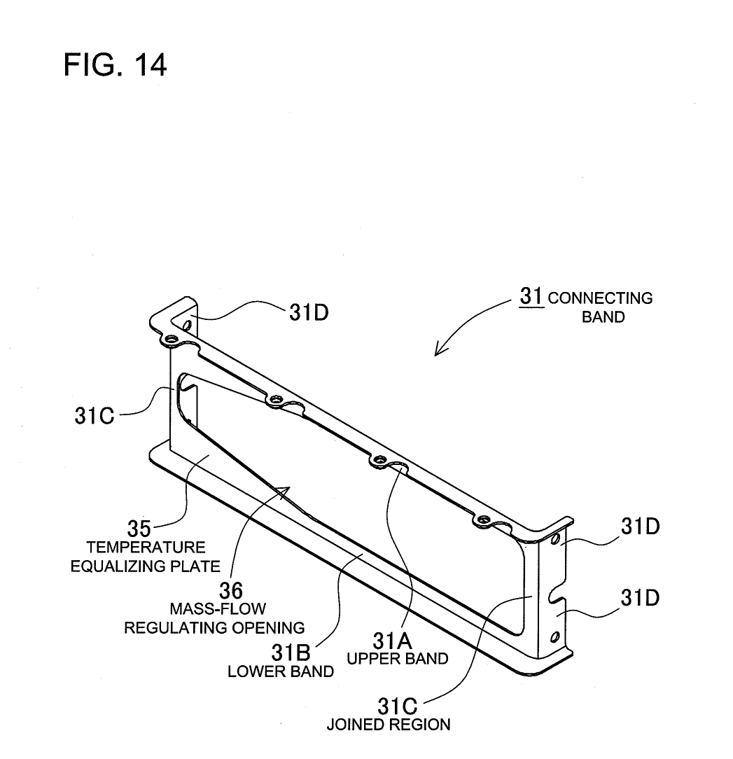

As shown in FIGS. 13 and 14, the temperature equalizing plates 35 can also be integrated as single-piece structures with the connecting bands 31. Each connecting band 31 has an upper band 31A and a lower band 31B disposed at the top and bottom edges of a battery stack 8. The upper band 31A and lower band 31B are joined together at both ends by the joined regions 31C, and bent regions 31D established in the joined regions 31C are attached to the endplates 10. A mass-flow regulating opening 36 is established between the upper band 31A and the lower band 31B of each temperature equalizing plate 35, and the opening width of the mass-flow regulating opening 36 varies in the battery cell 1 stacking direction. The mass-flow regulating openings 36 are formed in the temperature equalizing plates 35 during the connecting band 31 sheet-metal cut-out process. Since these temperature equalizing plates 35 are integrated as connecting bands 31, which are robustly attached to the battery blocks 30, temperature equalizing plate 35 position shift is reliably prevented allowing long-term reduction in battery cell 1 temperature differences.

The temperature equalizing plates 15, 35 pass supply duct 6 cooling gas through the mass-flow regulating openings 16, 36 into the cooling gaps 4. This is because the openings 14 of the cooling gaps 4 are exposed to the supply duct 6 through the mass-flow regulating openings 16, 36. To allow cooling gas to flow into each cooling gap 4, the mass-flow regulating openings 16, 36 have a shape that extends in the battery cell 1 stacking direction. The temperature equalizing plates 15, 35 of FIGS. 9 and 12-14 have mass-flow regulating openings 16, 36 that allow cooling gas flow into cooling gaps 4 of all the battery cells 1. However, in the battery system of the present invention with a configuration where cooling via cooling gas is not required in battery cells that remain relatively cool, it is unnecessary to expose the cooling gaps to the supply duct through the mass-flow regulating openings at cooling gaps contacting battery cells not requiring cooling. Consequently, it is not always necessary for the mass-flow regulating openings to expose all the cooling gaps to the supply duct. The temperature equalizing plates 15, 35 adjust the area of the cooling gap 4 openings 14 exposed to the supply duct 6 with the mass-flow regulating openings 6, 36 to control the amount of cooling gas flow into each cooling gap 4.

In battery blocks 3 with many battery cells 1 stacked together, If the exposed area of all the cooling gaps 4 is the same, the temperature of battery cells 1 at the upstream end of the supply duct 6 becomes lower than the temperature of battery cells 1 at the downstream end. This is because cooling gas flowing into the supply duct 6 by forced ventilation flows readily into cooling gaps 4 at the upstream end and flows less into cooling gaps 4 at the downstream end. The temperature equalizing plate 15 of FIG. 5 limits cooling of the upstream battery cells 1 and efficiently cools battery cells 1 at the downstream end. To accomplish this, the cooling gap 4 area exposed by the mass-flow regulating opening 16 increases towards the downstream end.

The temperature equalizing plate 15 of FIGS. 9 and 12 has a mass-flow regulating opening 16 between its upper and lower sections that extends lengthwise in the battery cell 1 stacking direction. This temperature equalizing plate 15 is provided with upper and lower closed-off sections 15A, a mass-flow regulating opening 16 between the upper and lower closed-off sections 15A, and connecting sections 15B that join the upper and lower closed-off sections 15A at both ends. The temperature equalizing plate 15 of the figures has a shape that can be attached to a connecting band 11 having a connected upper band 11A and lower band 11B. Specifically, the temperature equalizing plate 15 has a vertical width that can attach between the horizontal rib 11b of the upper band 11A and the horizontal rib 11b of the lower band 11B of a connecting band 11. The temperature equalizing plate 15 has a length that can attach to the outside surfaces of the joined regions 11C that join the connecting band 11 at both ends. This temperature equalizing plate 15 can be disposed with the upper and lower closed-off sections 15A on the surfaces of the upper band 11A and lower band 11B of the connecting band 11 to put the closed-off sections 15A in the closed-off regions of the connecting band 11. Consequently, while the temperature equalizing plate 15 has closed-off sections 15A at the top and bottom, the closed-off sections of this structure do not block the flow of cooling gas into cooling gaps 4 adjacent to battery cells 1 that become high in temperature. The entire perimeter of the temperature equalizing plate 15 can be sturdily attached to the connecting band 11 by bonding, by set screws, or by a snap-fit arrangement.

A temperature equalizing plate 15 with a rectangular shaped outer perimeter and a mass-flow regulating opening 16 established inside can be fabricated simply by pattern cutting sheet-metal or plastic plate.

The temperature equalizing plates 15 of FIGS. 3 and 5 have mass-flow regulating openings 16 that expose a smaller area at the upstream end than at the downstream end to limit cooling of the upstream battery cells 1 and reduce temperature differences between all the battery cells 1. A temperature equalizing plate 15 mass-flow regulating opening 16 is a means of controlling the amount of cooling gas flow into each cooling gap 4 by regulating the area of cooling gaps 4 exposed to the supply duct 6. Therefore, it is not always necessary for the mass-flow regulating opening to be shaped as shown in the figures. For example, a temperature equalizing plate can be provided with numerous through-holes and the size and density of those through-holes can be adjusted, or numerous slits can be provided to vary the exposed area in the battery cell stacking direction.

As shown in FIGS. 3-8, battery blocks 3 can be disposed in two separated rows, and ventilating ducts 5 can be established between and on the outside of the two rows of battery blocks 3. The battery system of FIGS. 3, 4, and 6 is made up of four battery blocks 3, two battery blocks 3 are joined in a straight-line to form a row of battery blocks 3, and the battery block 3 are arranged in two parallel rows. The two battery blocks 3 joined in a straight-line row are connected by stacking their endplates 10 together. Further, the two battery blocks 3 joined in a straight-line row are electrically connected in series by connecting positive and negative electrode terminals 13 via bus-bars 18. The battery system of the figures has a supply duct 6, which is connected with each cooling gap 4, established between the two rows of battery blocks 3. Further, exhaust ducts 7 are established on the outside of the two rows of separated battery blocks 3, and a plurality of parallel cooling gaps 4 connect between the supply duct 6 and exhaust ducts 7.

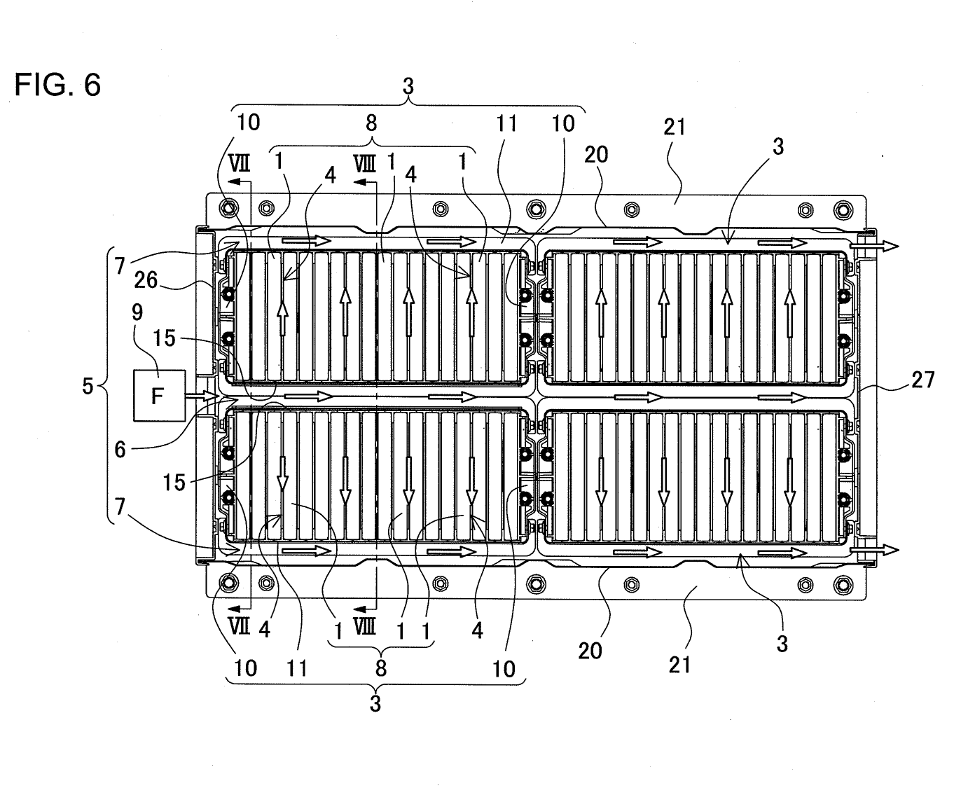

As shown in FIGS. 3 and 5-8, this battery system has temperature equalizing plates 15 attached to the side surfaces of the supply duct 6 side of battery blocks 3 disposed in two rows. Specifically, the temperature equalizing plates 15 are attached to the inside surfaces of the battery blocks 3 disposed in two rows. As shown by the arrows in FIGS. 3 and 6, the ventilating apparatus 9 forces cooling gas to flow from the supply duct 6 to the exhaust ducts 7 to cool the battery cells 1 in this battery system. As shown in FIGS. 7 and 8, cooling gas forced to flow from the supply duct 6 to the exhaust ducts 7 passes from the supply duct 6 through the temperature equalizing plate 15 mass-flow regulating openings 16, and branches into each cooling gap 4 to cool the battery cells 1. Cooling gas that has completed battery cell 1 cooling is collected in the exhaust ducts 7 and discharged outside the system.

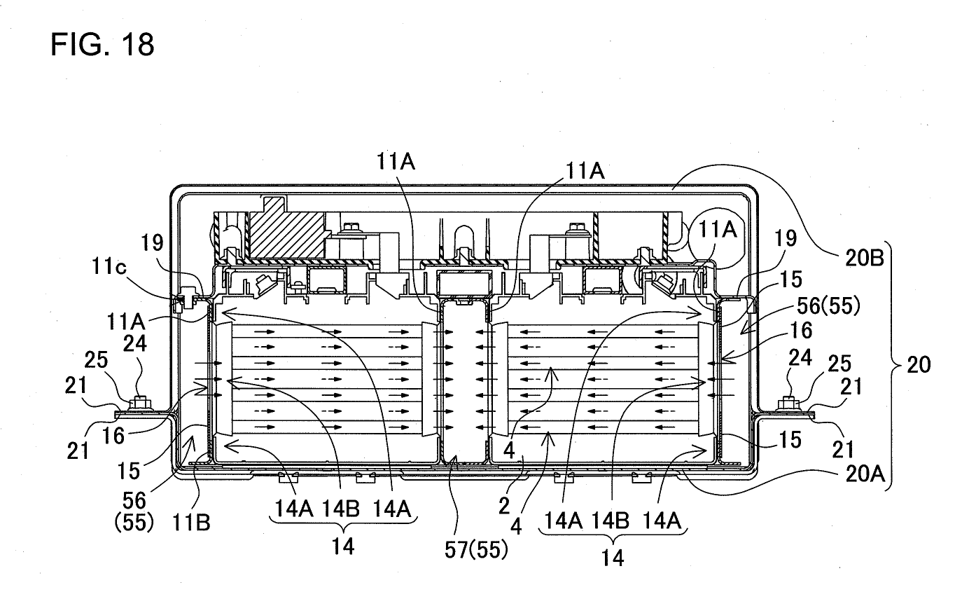

The battery system described above is provided with a supply duct 6 between two rows of battery blocks 3 and exhaust ducts 7 on the outsides. However, the battery system of the present invention can also have supply ducts and exhaust ducts disposed in reversed positions. The battery system shown in FIGS. 15-18 has supply ducts 56 established on the outside of two rows of battery blocks 3 and an exhaust duct 57 established between the two rows of battery blocks 3. A plurality of parallel cooling gaps 4 connect between the supply ducts 56 and the exhaust duct 57. The battery system of the figures has temperature equalizing plates 15 attached to the side surfaces of the supply duct 56 sides of the battery blocks 3. Specifically, the temperature equalizing plates 15 are attached to the outside surfaces of the battery blocks 3 disposed in two rows. These temperature equalizing plates 15 also have mass-flow regulating openings 16 that expose a smaller area at the upstream end than at the downstream end to limit cooling of the upstream battery cells 1 and reduce temperature differences between all the battery cells 1. As shown by the arrows in FIGS. 15-17, the ventilating apparatus 9 forces cooling gas to flow from the outer supply ducts 56 to the inner exhaust duct 57 to cool the battery cells 1 in this battery system. As shown in FIG. 18, cooling gas forced to flow from the outer supply ducts 56 to the inner exhaust duct 57 passes from the supply ducts 56 through the temperature equalizing plate 15 mass-flow regulating openings 16, and branches into each cooling gap 4 to cool the battery cells 1. Cooling gas that has completed battery cell 1 cooling is collected in the center exhaust duct 57 and discharged outside the system.

The cross-sectional area of a ventilating duct 5, 55 established between two parallel rows of battery blocks 3 is made twice the cross-sectional area of the ventilating ducts 5, 55 established on the outer sides of those battery blocks 3. This is because cooling gas forcibly introduced to a supply duct 6 between two rows of battery blocks 3 of the battery system shown in FIGS. 2-8 divides and flows to exhaust ducts 7 on both sides for discharge. Further, cooling gas forcibly introduced into two supply ducts 56 on both outer sides of the battery system shown in FIGS. 15-18 flows to the center exhaust duct 57 for discharge. Specifically, in the battery system shown in FIGS. 2-8, since the center supply duct 6 accommodates twice the flow accommodated by each outer side exhaust duct 7, the supply duct 6 cross-sectional area is made twice as large to reduce pressure losses. In the battery system of FIGS. 7 and 8, the lateral width of the center supply duct 6 is made twice the width of each exhaust duct 7 to enlarge the cross-sectional area of the center ventilating duct 5. Similarly, in the battery system shown in FIGS. 15-18, since the center exhaust duct 57 accommodates twice the flow accommodated by each outer side supply duct 56, the exhaust duct 57 cross-sectional area is made twice as large to reduce pressure losses. In the battery system of FIG. 18, the lateral width of the center exhaust duct 57 is made twice the width of each supply duct 56 to enlarge the cross-sectional area of the center ventilating duct 55.

In the battery systems described above, temperature equalizing plates 15 are attached to the side surfaces of the supply duct 6, 56 side(s) of the battery blocks 3. The amount of cooling gas flow from the supply duct(s) 6, 56 into the battery block 3 cooling gaps 4 is locally limited by the temperature equalizing plate 15 mass-flow regulating openings 16 to reduce battery cell 1 temperature differences. However, the battery system of the present invention can also be provided with temperature equalizing plates on the side surfaces of the exhaust duct side(s) of the battery blocks, or with temperature equalizing plates on the side surfaces of both the supply duct side(s) and the exhaust duct side(s) of the battery blocks.

The battery system shown in FIGS. 19-21 has a supply duct 6 established between two rows of battery blocks 3 and exhaust ducts 7 established on the outside of the two rows of battery blocks 3. The battery system of the figures has temperature equalizing plates 45 attached to the side surfaces of the exhaust duct 7 sides of the battery blocks 3. Specifically, the temperature equalizing plates 45 are attached to the outside surfaces of the battery blocks 3 disposed in two rows. These temperature equalizing plates 45 also have mass-flow regulating openings 46 that extend lengthwise in the battery cell 1 stacking direction. The mass-flow regulating openings 46 of the figures expose a smaller area at the upstream end than at the downstream end to limit cooling of the upstream battery cells 1 and reduce temperature differences between all the battery cells 1. As shown by the arrows in the figures, the ventilating apparatus 9 forces cooling gas to flow from the inner supply duct 6 to the outer exhaust ducts 7 to cool the battery cells 1 in this battery system. Cooling gas forced to flow from the inner supply duct 6 to the outer exhaust ducts 7 branches from the supply duct 6 into each cooling gap 4. Cooling gas that has flowed through the cooling gaps 4 passes through the temperature equalizing plate 45 mass-flow regulating openings 46 disposed on the exhaust duct 7 sides, and is discharged into the exhaust ducts 7. In this battery system, the temperature equalizing plates 45 disposed on the exhaust duct 7 sides limit the amount of cooling gas flow through the battery block 3 cooling gaps 4 into the exhaust ducts 7 to reduce battery cell 1 temperature differences.

Further, the battery system shown in FIGS. 22-24 has battery blocks disposed in two separated rows, has supply ducts 56 established on the outside of the two rows of battery blocks 3, and has an exhaust duct 57 established between the two rows of battery blocks 3. The battery system of the figures has temperature equalizing plates 45 attached to the side surfaces of the exhaust duct 57 side of the battery blocks 3. Specifically, the temperature equalizing plates 45 are attached to the inside surfaces of the battery blocks 3 disposed in two rows. These temperature equalizing plates 45 also have mass-flow regulating openings 46 that extend lengthwise in the battery cell 1 stacking direction. The mass-flow regulating openings 46 of the figures expose a smaller area at the upstream end than at the downstream end to limit cooling of the upstream battery cells 1 and reduce temperature differences between all the battery cells 1. As shown by the arrows in the figures, the ventilating apparatus 9 forces cooling gas to flow from the outer supply ducts 56 to the center exhaust duct 57 to cool the battery cells 1 in this battery system. Cooling gas forced to flow from the outer supply ducts 56 to the center exhaust duct 57 branches from the supply ducts 56 into each cooling gap 4. Cooling gas that has flowed through the cooling gaps 4 passes through the temperature equalizing plate 45 mass-flow regulating openings 46 disposed on the exhaust duct 57 side, and is discharged into the exhaust duct 57. In this battery system as well, the temperature equalizing plates 45 disposed on the exhaust duct 57 side limit the amount of cooling gas flow through the battery block 3 cooling gaps 4 into the exhaust duct 57 to reduce battery cell 1 temperature differences.

The battery blocks 3 of each battery system described above are disposed in two rows and mounted in an external case 20. The external case 20 of the battery system shown in the figures is made up of an upper case 20B and a lower case 20A. The upper case 20B and the lower case 20A have flanges 21 that project outward, and these flanges 21 are joined by nuts 25 and bolts 24. The external case 20 of the figures has flanges 21 disposed outside the side surfaces of the battery blocks 3. However, the flanges can also be disposed at the top, bottom, or intermediate location with respect to the battery blocks. The battery blocks 3 are attached to the external case 20 by attaching the endplates 10 to the lower case 20A with set screws (not illustrated). Set screws are passed through holes in the lower case 20A and screwed into screw-holes (not illustrated) in the endplates 10 to attach the battery blocks 3 to the external case 20. The heads of the set screws protrude from the bottom of the lower case 20A.

Further, the external case 20 has end-plane walls 26, 27 attached at both ends. The end-plane walls 26, 27 are joined to the external case 20 and provided with outward protruding connecting ducts 28, 29. The connecting ducts 28, 29 are formed as a single piece with the end-plane walls 26, 27 from a material such as plastic and connect internally to the ventilating ducts 5, 55, which are the supply duct(s) 6, 56 and exhaust duct(s) 7, 57. These connecting ducts 28, 29 connect to the ventilating apparatus 9 and to external discharge ducts (not illustrated) that discharge the cooling gas from the battery system. The end-plane walls 26, 27 are attached to battery block endplates by set screws. However, the end-plane walls can also attach to the battery blocks, or to the external case, by a fastening configuration other than set screw attachment.

The battery systems described above have battery blocks 3 arranged in two parallel rows, and ventilating ducts 5, 55 are established at the center and outer sides of the two rows of battery blocks 3. However, the battery system can also be configured with a single row of battery blocks. Although not illustrated, the battery system can be provided with ventilating ducts on both sides of a single row of battery blocks. The ventilating duct on one side can be the supply duct, and the ventilating duct on the other side can be the exhaust duct. This battery system can have a temperature equalizing plate attached to the supply duct side surface, the exhaust duct side surface, or to both side surfaces of the single row of battery blocks. These temperature equalizing plates also have mass-flow regulating openings that expose a smaller area at the upstream end than at the downstream end to limit cooling of the upstream battery cells and reduce temperature differences between all the battery cells. In this battery system, the ventilating apparatus forces cooling gas to flow from the supply duct towards the exhaust duct to cool the battery cells. Since the amount of cooling gas flow in the supply duct and exhaust duct is equal, the cross-sectional areas of the supply duct and exhaust duct established on both sides of the battery block can be made equal. Specifically, the lateral width of the supply duct can be made equal to the lateral width of the exhaust duct.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims.

The present application is based on Application No. 2009-121337 filed in Japan on May 19, 2009, the content of which is incorporated herein by reference.

What is claimed is:

1. A battery system comprising:
battery blocks having a plurality of battery cells stacked with intervening cooling gaps;
ventilating ducts that are supply ducts and exhaust ducts disposed on each side of the battery blocks to forcibly ventilate the cooling gaps to cool the battery cells; and
ventilating apparatus to force cooling gas to flow through the ventilating ducts,
wherein cooling gas forcibly introduced by the ventilating apparatus flows from the supply ducts through the cooling gaps and into the exhaust ducts to cool the battery cells,
wherein temperature equalizing plates are disposed on the ventilating duct side surfaces of the battery blocks,
wherein the temperature equalizing plates are provided with mass-flow regulating openings extending lengthwise in the battery cell stacking direction to induce the flow of ventilating duct cooling gas through each cooling gap,
wherein the surface area exposed by a mass-flow regulating opening varies with position in the battery cell stacking direction, and
wherein cooling gas flowing through each cooling gap passes through ventilating duct mass-flow regulating openings to equalize the temperature of all the battery cells.

2. The battery system as cited in claim 1 wherein temperature equalizing plates are disposed on the supply duct side surfaces of the battery blocks,
wherein the temperature equalizing plates are provided with mass-flow regulating openings extending lengthwise in the battery cell stacking direction to induce the flow of supply duct cooling gas through each cooling gap,
wherein the surface area exposed by a mass-flow regulating opening varies with position in the battery cell stacking direction; and supply duct cooling gas passes through the mass-flow regulating openings into each cooling gap to equalize the temperature of all the battery cells.

3. The battery system as cited in claim 1 wherein temperature equalizing plates are disposed on the exhaust duct side surfaces of the battery blocks,
wherein the temperature equalizing plates are provided with mass-flow regulating openings extending lengthwise in the battery cell stacking direction to discharge cooling gas that has flowed through each cooling gap into the exhaust ducts
wherein the surface area exposed by a mass-flow regulating opening varies with position in the battery cell stacking direction; and cooling gas that has flowed through each cooling gap passes through the mass-flow regulating openings and is discharged into the exhaust ducts to equalize the temperature of all the battery cells.

4. The battery system as cited in claim 1 wherein a battery block is provided with a battery stack having a plurality of battery cells stacked together, a pair of endplates disposed at the ends of the battery stack, and connecting bands that connect the pair of endplates to sandwich the battery stack from both ends via the endplates and hold the battery cells in a stacked arrangement.

5. The battery system as cited in claim 4 wherein the connecting bands are disposed on both side surfaces of the battery stack, and a temperature equalizing plate is attached in a laminated manner to a connecting band.

6. The battery system as cited in claim 5 wherein the temperature equalizing plate is provided with upper and lower closed-off sections, and a mass-flow regulating opening is established between the upper and lower closed-off sections.

7. The battery system as cited in claim 6 wherein the upper and lower closed-off sections are joined at both ends by connecting sections.

8. The battery system as cited in claim 5 wherein the temperature equalizing plate has a shape that can attach to a connecting band.

9. The battery system as cited in claim 5 wherein the temperature equalizing plate is bond-attached to the surface of a connecting band.

10. The battery system as cited in claim 4 wherein the connecting bands are disposed on both side surfaces of the battery stack, and a temperature equalizing plate is integrated in a single-piece configuration with a connecting band.

11. The battery system as cited in claim 1 wherein a temperature equalizing plate mass-flow regulating opening exposes a smaller area at the upstream end than at the downstream end.

12. The battery system as cited in claim 11 wherein a temperature equalizing plate mass-flow regulating opening has a narrower vertical width at the upstream end than at the downstream end to reduce the exposed area at the upstream end.

13. The battery system as cited in claim 4 wherein the connecting bands are disposed at the top and bottom of the battery stack.

14. The battery system as cited in claim 4 wherein a connecting band has an upper band and a lower band disposed at the top and bottom of a battery stack and joined together at both ends, and the joined regions attach to the endplates.

15. The battery system as cited in claim 14 wherein a temperature equalizing plate is integrated in a single-piece configuration with the connecting band, and the temperature equalizing plate is provided with a mass-flow regulating opening between the upper band and the lower band that varies in opening width in the battery cell stacking direction.

16. The battery system as cited in claim 1 wherein the battery blocks are disposed in two separated rows, ventilating ducts are established between and on the outside of the two rows of battery blocks, and temperature equalizing plates are disposed between the two rows of battery blocks.

17. The battery system as cited in claim 1 wherein the battery blocks are disposed in two separated rows, ventilating ducts are established between and on the outside of the two rows of battery blocks, and temperature equalizing plates are disposed on the outside of the two rows of battery blocks.

18. The battery system as cited in claim 1 which is used as a power source in an electric powered vehicle.
